(19) United States
(12) Patent Application Publication
(10) Pub. No.: US 2012/0118208 A1
(43) Pub. Date: May 17, 2012

(54) WINCH AND AUTONOMOUS MOBILE APPARATUS INCLUDING THE SAME

(75) Inventors: Sang-Whee Kim, Gyeonggi-do (KR); Seong Ho Kim, Daejeon (KR); Hyun Goo Kim, Daejeon (KR); Young Jun Park, Daejeon (KR); Ki Soo Cho, Gyeonggi-do (KR)

(73) Assignee: Samsung Heavy Ind. Co., Ltd., Seoul (KR)

(21) Appl. No.: 13/263,273

(22) PCT Filed: Apr. 1, 2010
(86) PCT No.: PCT/KR10/02019

§ 371 Date: Jan. 26, 2012

(30) Foreign Application Priority Data
Apr. 6, 2009 (KR) 10-2009-0029629

(51) Int. Cl. B66D 1/28; F16M 13/00

(52) U.S. Cl. 108/20; 254/331

(57) ABSTRACT

The present invention discloses a winch and an autonomous mobile apparatus including the winch. The winch can include: a driving motor; a driving axle configured to rotate by having a driving force transferred from the driving motor; a wire drum installed on the driving axle in such a way that the wire drum is rotated by the driving axle and can move along the driving axle, a first screw part formed on an external circumferential surface of lengthwise end thereof; and a guide part arranged to be parallel to the driving axle and having a second screw part formed on a lateral side that faces the driving axle, the second screw part being extended in a lengthwise direction of the driving axle and engaged with the first screw part. The wire drum can move along the guide part in such a way that the length of a wire being wound or unwound for one rotation of the wire drum is constant.

### TECHNICAL FIELD

The present invention relates to a winch and an autonomous mobile apparatus including the winch, more specifically to a winch that is configured to precisely control the length of a wire being wound or unwound and an autonomous mobile apparatus having the winch.

### BACKGROUND ART

In general, an autonomous mobile apparatus is used inside a block of a hull in order to carry out tasks such as welding, cutting, etc. automatically. The autonomous mobile apparatus is operated in such a way that a robot-mountable platform moves inside the block of the hull by use of a plurality of wires.

Here, a winch installed in the platform repeatedly winds and unwinds the wire that is coupled with an inner wall of the block of the hull so that the platform can move freely inside the block of the hull. Furthermore, the length of the wire that is wound and unwound by the winch needs to be precisely controlled in order to move the platform to a desired position inside the block of the hull.

However, the commonly-used winch is operated to wind or unwind the wire by simply having a drum rotated by a motor. In other words, the commonly-used winch is operated to wind or unwind the wire through an on/off control of the motor. Accordingly, it has been impossible to precisely control the length of the wire that is wound or unwound by the winch.

Moreover, since the common winch has no alignment function, it is possible that the wire is overlapped when the wire is wound. In case the wire is overlapped when the wire is wound, the amount of rotation of the motor for winding the wire on the winch is changed. Therefore, it becomes impossible to define the length of the wire wound for a given amount of rotation of the motor, disabling precise control of the winch.

Moreover, as the common winch overlaps the wire when winding the wire, the position of discharging the wire is changed. Accordingly, it has been impossible to define the discharge position of the wire for precise control of the winch.

### DISCLOSURE

### Technical Problem

Contrived to solve the above problems, the present invention provides a winch and an autonomous mobile apparatus including the winch that can control the length of the wire precisely.

The present invention also provides a winch that is configured to maintain the position of the wire being wound on or unwound from the wire drum and an autonomous mobile apparatus including the winch.

### Technical Solution

Contrived to solve the above problems, an aspect of the present invention features a winch that can include: a driving motor; a driving axle configured to rotate by having a driving force transferred from the driving motor; a wire drum installed on the driving axle in such a way that the wire drum is rotated by the driving axle and can move along the driving axle, a first screw part formed on an external circumferential surface of lengthwise end thereof; and a guide part arranged to be parallel to the driving axle and having a second screw part formed on a lateral side that faces the driving axle, the second screw part being extended in a lengthwise direction of the driving axle and engaged with the first screw part. The wire drum can move along the guide part in such a way that the length of a wire being wound or unwound for one rotation of the wire drum is constant.

The wire can begin to be wound on or unwound from the wire drum at a predetermined position in a lengthwise direction of the guide part when the wire drum moves along the guide part.

A wire outlet facing a direction that is perpendicular to the lengthwise direction of the guide part can be formed in the winch, and the wire can begin to be wound on or unwound from the wire drum at a middle position of the wire outlet when the wire drum moves along the guide part.

The winch can also include a supporting roller arranged in between the wire drum and the wire outlet and configured to support the wire passing through the wire outlet in such a way that the wire passes the middle position of the wire outlet.

The winch can also include a supplementary roller arranged to be in contact with or adjacent to an outer circumferential end of the supporting roller in such a way that the wire supported by the supporting roller is prevented from escaping from the supporting roller and having a rotation axis that is parallel to a rotation axis of the supporting roller.

The winch can also include a load cell arranged to be adjacent to the supporting roller in order to measure tension of the wire supported by the supporting roller. The driving axle can be a ball spline axle having a groove extended in the lengthwise direction of the driving axle, and a ball spline nut having balls that are inserted in the groove is formed inside the wire drum.

The first screw part of the wire drum can be formed on both lengthwise ends of the wire drum.

The winch can also include: a first encoder installed in the driving motor in order to measure an amount of rotation of the driving motor;

a second encoder installed on an end part of the driving axle in order to measure an amount of rotation of the wire drum; and a controller configured to receive the amount of rotation of the driving motor measured by the first encoder and the amount of rotation of the wire drum measured by the second encoder and, if there is a difference between a ratio of the measured amount of rotation of the wire drum for the measured amount of rotation of the driving and a predetermined value, to rotate the driving motor in order to compensate for the difference by additionally rotating the wire drum.

The wire drum can include a guide groove spirally formed continuously on an external circumferential surface of the wire drum in such a way that the wire wound on the wire drum is wound in an aligned fashion.

The winch can also include a pinch roller arranged to be parallel to the driving axle and configured to press down the wire wound on the wire drum toward a center of the wire drum.

Another aspect of the present invention features an autonomous mobile apparatus movable in a predetermined work space. The autonomous mobile apparatus can include: a mobile platform placed inside the work space; a winch of any of claims 1 to 8 installed in the mobile platform; and a wire having one end coupled to a supporting structure defining the work space and the other end coupled to the winch.

### Advantageous Effects

According to an aspect of the present invention, it becomes possible to precisely control the length of the wire that is wound or unwound per 1 rotation of the wire drum by having the wire drum rotate and move along the guide part so that the wire is aligned to be wound on or unwound from the wire drum in an orderly fashion.

Moreover, as the wire drum of the winch rotates and moves along the guide part, the position of the wire getting discharged becomes constant when the wire is wound or unwound.

Furthermore, by controlling the driving motor by use of the first encoder measuring the amount of rotation of the driving motor and the second encoder measuring the amount of rotation of the wire drum, it becomes possible to precisely control the length of the wire.

According to another aspect of the present invention, the autonomous mobile apparatus including the winch that can precisely control the length of the wire that is wound or unwound can be moved precisely a desired location inside a work space.

### DESCRIPTION OF DRAWINGS

FIG. 1 is a diagram briefly showing an autonomous mobile apparatus including a winch in accordance with an embodiment of the present invention.

FIG. 2 is a perspective view of the winch viewed from a rear side in accordance with an embodiment of the present invention.

FIG. 3 is a cross-sectional view of FIG. 2 along the “I-I” line.

FIG. 4 is a cross-sectional view of FIG. 3 along the “II-II” line.

FIG. 5 is a top view of the winch in accordance with an embodiment of the present invention.

FIG. 6 is a top view showing an operational state of the winch in accordance with an embodiment of the present invention.

FIG. 7 is a diagram showing the relation of a first encoder, a second encoder, a controller and a driving motor of the winch in accordance with an embodiment of the present invention.

### MODE FOR INVENTION

Hereinafter, an embodiment of the present invention will be described in detail with reference to the accompanying drawings. Any identical or corresponding elements will be assigned with identical reference numerals, and they will not be described redundantly.

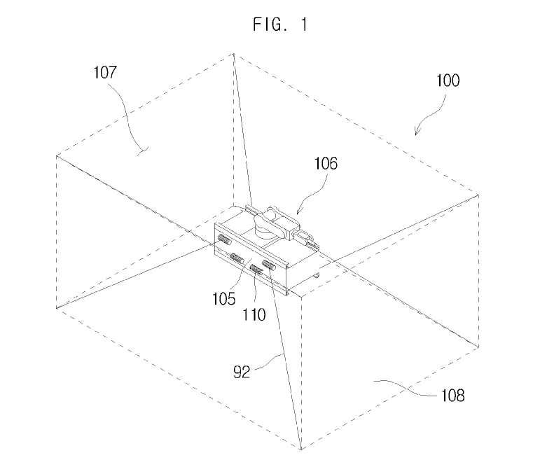

FIG. 1 is a diagram briefly showing an autonomous mobile apparatus 100 including a winch in accordance with an embodiment of the present invention. The autonomous mobile apparatus 100 moves freely in a predetermined work space 107, such as an inside of a block of a hull.

Referring to FIG. 1, the autonomous mobile apparatus 100 includes a mobile platform 105, a winch 110 and a wire 92. The mobile platform 105 is placed and moves inside the work space 107. Mounted moveably on an upper side along a lengthwise direction of the mobile platform 105 is work equipment 106, which can perform tasks such as welding, cutting and painting. Moreover, work equipment that can perform tasks such as blasting and retrieving grit can be moveably mounted on a lower side along a lengthwise direction of the mobile platform 105.

A plurality of winches 110 are installed in the mobile platform 105. The winch 110 is coupled with the other end of the wire 92, one end of which is coupled with a supporting structure 108 defining the work space 107. Here, the supporting structure defining the work space refers to, for example, a partition wall that demarks a block of a hull, and there can be various other forms of supporting structures in the present embodiment.

The autonomous mobile apparatus 100 configured as described above is operated in such a way that the mobile platform 105 can move freely inside the work space 107 as the winch 110 is used to wind or unwind the wire 92 coupled with the winch 110.

Here, the winch 110 in accordance with the present embodiment is configured to precisely control the length of the wire 92 that is wound or unwound. Accordingly, the autonomous mobile apparatus 100 is operated to move the mobile platform 105 precisely to a desired location of the work space 107.

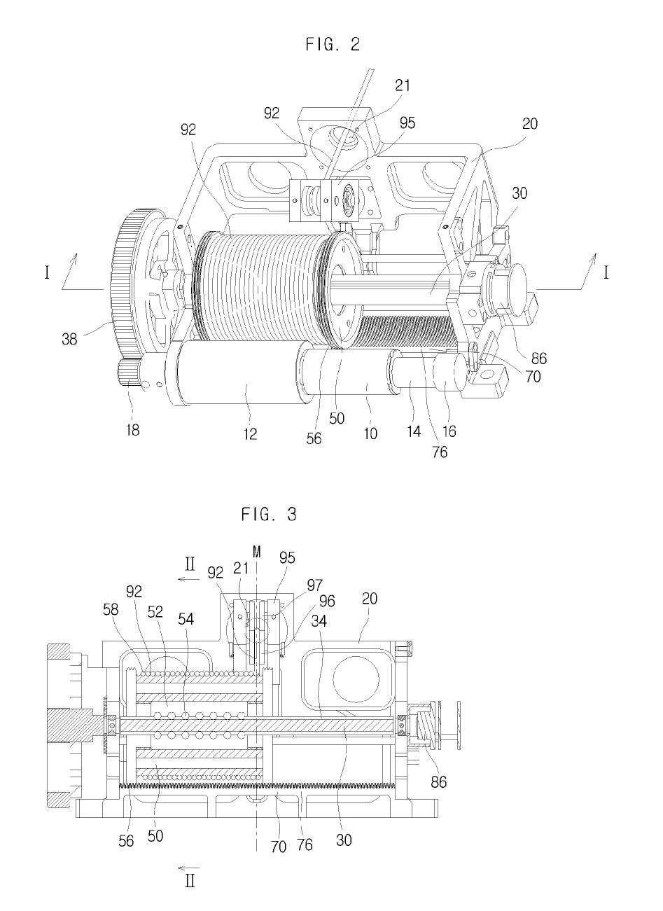

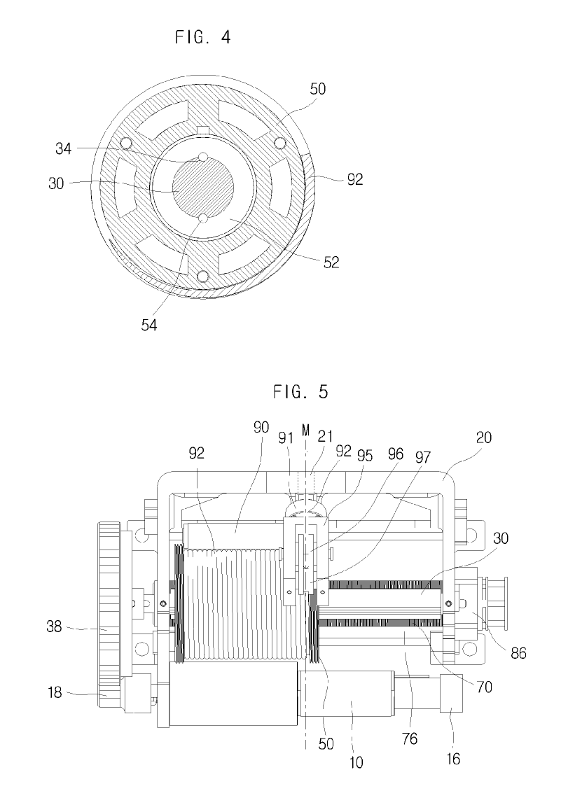

Hereinafter, the winch in accordance with the present embodiment will be described in detail. FIG. 2 is a perspective view of the winch viewed from a rear side in accordance with an embodiment of the present invention. FIG. 3 is a cross-sectional view of FIG. 2 along the “I-I” line, and FIG. 4 is a cross-sectional view of FIG. 3 along the “II-II” line. FIG. 5 is a top view of the winch in accordance with an embodiment of the present invention.

Referring to FIG. 2, the winch in accordance with the present embodiment includes a driving motor 10, a driving axle 30, a wire drum 50 and a guide part 70.

The driving motor 10 provides a driving force for rotating the driving axle, which will be described later. Referring to FIG. 2, the driving motor 10 is coupled with a decelerator 12 and a motor brake 14. However, the decelerator and motor brake that are connected with the driving motor 10 can be selectively applied. The driving motor 10 is installed in a supporting frame 20. In the present embodiment, the supporting frame, which is a supporting structure for supporting an element such as the driving motor 10, is installed in the mobile platform 105. The driving axle 20, which is rotated by receiving the driving force from the driving motor 10, is installed in the supporting frame 20.

A motor gear 18 is installed at one end part of the driving motor 10 in order to transfer the driving force of the driving motor 10 to the driving axle 30, and a drum gear 38, which is engaged with the motor gear 18, is installed at one end part of the driving axle 30.

Referring to FIG. 2, the wire drum 50 is installed on the driving axle 30. The wire drum 50, which is configured to wind the wire 92, is formed in the shape of a cylinder. In the present embodiment, the wire drum 50 is installed on the driving axle 30 in such a way that the wire drum 50 is rotated by the driving axle 30 and can move along the driving axle 30.

For this, as illustrated in FIGS. 3 and 4, the driving axle 30 is a ball spline axle in which a groove 34 is extended in a lengthwise direction thereof, and a ball spline nut 52 having balls 34 that are inserted in the groove 34 can be formed inside the wire drum 50.

Here, as it can be seen in FIG. 4, the balls 54 are caught in the groove 34 when the driving axle 30 rotates. Accordingly, the wire drum 50 including the ball spline nut 52 can be rotated with the driving axle 30.

Moreover, as it can be seen in FIG. 3, the balls 54 are rolled along the groove 34 in the lengthwise direction of the driving axle 30. Accordingly, the wire drum 50 including the ball spline nut 52 can move in the lengthwise direction of the driving axle 30.

Although it is described in the present embodiment that the driving axle is a ball spline axle and the ball spline nut is formed inside the wire drum in order to have the wire drum rotated by the driving axle and move along the driving axle, this is only an example, and there can be various mechanisms in which the wire drum is rotated by the driving axle and move along the driving axle.

The wire drum 50 of the present embodiment has a first screw part 56 formed on external circumferential surfaces of both lengthwise ends thereof. The first screw part 56 is engaged with a second screw part 76 formed on the guide part 70, which will be described later.

However, the first screw part 56 is not necessarily formed on both ends of the wire drum 50 but can be formed on one end of the wire drum 50.

Referring to FIG. 3, the wire drum 50 has a guide groove 59 that is spirally formed continuously on an external circumferential surface that is in contact with the wire 92 wound on the wire drum 50. The guide groove 58 guides the wire to be wound in an aligned fashion on the wire drum 50 when the wire drum 50 rotates in a direction of winding the wire and moves along the guide part.

The present embodiment also includes a pinch roller 90 that is arranged to be parallel with the driving axle 30. Referring to FIG. 5, the pinch roller 90 is installed in the supporting frame 20. The pinch roller 90 presses down the wire 92 wound on the wire drum 50 toward a center of the wire drum 50.

Referring to FIGS. 2 and 3, the guide part 70, which is arranged to be parallel to the driving axle 30, is formed on a facing side of the driving axle 30. The guide part 70 is formed in one body with the supporting frame 70 but can be separately made and arranged.

The guide part 70 has the second screw part 76, which is extended in the lengthwise direction of the driving axle 30, on a lateral side that faces the driving axle 30. Referring to FIG. 3, the second screw part 76 is engaged with the first screw part 56. Accordingly, the wire drum 50 can move along the guide part 70 as the wire drum 50 rotates.

Accordingly, the wire drum 50 rotates and spin-moves along the guide part 70 in such a way that the wire 92 can be neatly wound on the wire drum 50 or unwound from the wire drum 50 in an orderly fashion. As a result, the length of the wire wound or unwound per each rotation of the wire drum 50 becomes constant.

In such a case, screw threads formed on the first screw part 56 and the second screw part 76 have a fixed pitch. This means that every time when the wire drum 50 makes one full rotation, the distance by which the wire drum 50 moves along the guide part 90 is maintained constant.

Accordingly, when the wire drum 50 moves along the guide part 70, the wire 92 begins to be wound on or unwound from the wire drum 50 at a predetermined position in a lengthwise direction of the guide part 70.

As illustrated in FIG. 2, a wire outlet 21 oriented toward a direction that is perpendicular to the lengthwise direction of the guide part 70 is formed in the winch 110 in accordance with the present embodiment. The wire outlet 21 is formed by processing a portion of the supporting frame 20.

As it can be seen in FIG. 3, the winch 110 in accordance with the present embodiment is operated to allow the wire 92 to start winding on or unwinding from the wire drum 50 at a middle position (M) of the wire outlet when the wire drum 50 moves along the guide part 70.

Here, the middle position of the wire outlet refers to a position at which a plane that passes through a center of the wire outlet and is perpendicular to the lengthwise direction of the guide part and the guide part meet, and is illustrated with “M” in FIG. 3.

In the present embodiment, the winch 110 also includes a supporting roller 96, which is arranged in between the wire outlet 21 and the wire drum 50. The supporting roller 96 supports the wire 92 to pass through the middle of the wire outlet 21. The supporting roller 96 is rotatably installed in a roller supporting part 95, and an end part of the roller supporting part 95 is installed on the supporting frame 20.

In the present embodiment, the winch 110 also includes a supplementary roller 97 having a rotation axis that is parallel to a rotation axis of the supporting roller 96. The supplementary roller 97 prevents the wire 92 supported by the supporting roller 96 from escaping from the supporting roller 96. The supplementary roller 97 is arranged by being in contact with or adjacent to an outer circumferential end of the supporting roller 96 and is rotatably installed on the roller supporting part 95.

Referring FIG. 5, the winch 110 of the present embodiment also includes a load cell 91 that is arranged by being adjacent to the supporting roller 95. The load cell 91, which is for measuring the tension of the wire 92 supported by the supporting roller 96, is installed on an end part of the roller supporting part 95 on which the supporting roller 96 is installed.

Once the wire supported by the supporting roller 96 has tension, the supporting roller 96 provides a load toward the load cell 91, In such a case, the tension of the wire can be measured through the load provided to the load cell 91.

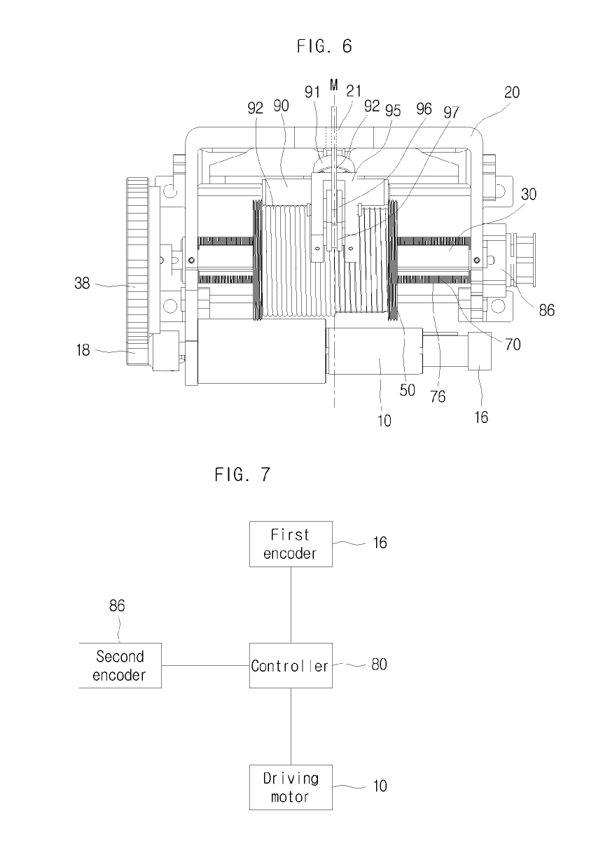

FIG. 6 is a top view for describing an operational state of the winch in accordance with an embodiment of the present invention. Hereinafter, the operation of the winch in accordance with an embodiment of the present invention will be described with reference to FIGS. 2, 5 and 6.

Referring to FIGS. 2 and 5 first, when the wire drum 50 is rotated by the driving motor 10 in a direction of unwinding the wire, the wire drum 50 becomes to move to the right-side direction of the driving axle 30 as the first screw parts 56 formed on both ends of the wire drum 50 are engaged with the second screw part 76 formed on a lateral side of the guide part 70.

In such a case, the wire drum 50 moves to the right-side of the driving axle 30, and at the same time, the wire 92 having been wound on the wire drum 50 is unwound from the wire drum 50 in an orderly fashion.

The wire 92 being unwound from the wire drum 50 is supported by the supporting roller 96 and is transported to an outside through the wire outlet 21.

Afterwards, the wire drum 50 moves to a position illustrated in FIG. 6 along the driving axle 10. Here, if the wire is to be unwound continuously, the driving motor 10 continues to rotate in the same direction, rotating the wire drum 50. Accordingly, the wire drum 50 continues to move to the right-side, continually unwinding the wire 92 in an orderly fashion.

However, if the wire 92 needs to be wound, the driving motor 10 rotates in an opposite direction, and accordingly the wire drum 50 moves to the left-side of the driving axle 10. In such a case, the wire drum moves to the left-side of the driving axle 30, and at the same time, the wire 92 transported to the outside of the winch is wound on the wire drum 50 in an orderly fashion.

Here, the winch 110 in accordance with the present embodiment is operated in such a way that the wire 92 is wound on or unwound from the wire drum 50 at the middle position (M) of the wire outlet 21 that is a predetermined position in the lengthwise direction of the guide part 70. Accordingly, the winch 110 in accordance with the present embodiment can maintain the position of discharging the wire to be constant while the wire is wound or unwound.

Moreover, in the present embodiment, the winch 110 is operated in such a way that the length of the wire being wound on or unwound from the wire drum 50 is constant for each rotation of the wire drum 50. Accordingly, the winch in accordance with an embodiment of the present invention can precisely control the length of the wire that is wound on or unwound from the wire drum 50.

In the present embodiment, the length of the wire being wound or unwound is the same when the wire drum 50 makes one full rotation. Accordingly, the amount of rotation of the wire drum 50 can be predetermined in order to wind or unwind a particular length of the wire.

The driving motor 10 transferring the driving force to the wire drum 50 is connected through a gear to the driving axle 30 that rotates the wire drum 50. Here, by a gear ratio among the gears connecting the driving motor 10 with the driving axle 30, the amount of rotation of the wire drum 50 per one rotation of the driving motor 10 is predetermined

Considering the above, the ratio of the amount of rotation of the wire drum 50 for the amount of rotation of the driving motor 10 for winding or unwinding a particular length of the wire is predetermined in the process of designing the winch. For example, if the winch is designed in such a way that the driving motor makes 100 rotations and the wire drum makes 10 rotations in order to wind 5 m of the wire, the ratio of the amount of rotation of the wire drum for the amount of rotation of the driving motor is predetermined to be 10/100 (i.e., 1/10).

However, in the process of manufacturing the winch, the ratio of the amount of rotation of the wire drum for the amount of rotation of the driving motor can be different from the predetermined value due to a manufacturing error of the winch or because the gears connecting the driving motor with the driving axle are worn out while the winch is used.

To solve this, the winch in accordance with an embodiment of the present invention also includes two encoders and a controller. FIG. 7 is a diagram showing the relation of a first encoder 16, a second encoder 86 and a controller 80 included in the winch in accordance with an embodiment of the present invention. More specifically, referring to FIGS. 2 and 7, the driving motor 10 is installed with the first encoder 16 for measuring the amount of rotation of the driving motor 10, and the other end of the driving axle 30 is installed with the second encoder 86 for measuring the amount of rotation of the wire drum 50 that rotates with the driving axle 30.

The controller 80 can be installed in the supporting frame 20 and arranged to be adjacent to the first encoder 16 and the second encoder 86, but can be separated from the supporting frame 20 and arranged remotely from the first encoder 16 and the second encoder 86. Moreover, the controller 80 can be connected with the first encoder 16 and the second encoder 86 by wire or wirelessly.

In case, for example, the driving motor 10 is operated to rotate the wire drum 50 in order to wind or unwind a particular length of the wire, the controller 80 receives data for the amount of rotation of the driving motor 10 from the first encoder 16 and receives data for the amount of rotation of the wire drum 50 from the second encoder 86.

Then, the controller 80 compares the ratio of a value measured by the second encoder 86 for a value measured by the first encoder 16 with a predetermined value. If there is a difference between the ratio of the measured values and the predetermined value, the controller 80 rotates the driving motor 10 to rotate the wire drum 50 additionally in order to compensate for the difference.

For example, supposing that the winch in accordance with an embodiment of the present invention is designed to have the driving motor 10 rotate 100 times and the wire drum 50 rotate 10 times in order to wind 5 m of the wire, the ratio of the amount of rotation of the wire drum 50 for the amount of rotation of the driving motor 10 is predetermined to be 10/100.

Here, if the driving motor 10 rotates 100 times in order to wind 5 m of the wire, the value measured by the first encoder 16 is 100 times. Here, if the amount of rotation of the wire drum 50 measured by the second encoder is 9.5 times, the ratio of the values measured by the first encoder 16 and the second encoder 86 becomes 9.5/100.

As such, when there is a difference between the ratio of the measured values and the predetermined value, the controller 80 rotates the driving motor 10 to have the wire drum 50 rotate a half circle more in order to compensate for the difference.

Therefore, the wire drum 50 in accordance with an embodiment of the present invention can wind the originally intended length of 5 m of the wire by making the total of 10 rotations by making an additional 0.5 rotation after initially rotating 9.5 times.

As such, with the winch in accordance with an embodiment of the present invention, the driving motor can be additionally operated to additionally rotate the wire drum in case there is an insufficient amount of rotations of the wire drum that is initially rotated by the driving motor with the purpose of winding or unwinding a particular length of the wire. As a result, it is possible to wind or unwind the originally intended length of the wire, making it possible to precisely control the length of the wire.

Furthermore, the autonomous mobile apparatus including the winch that can precisely control the length of the wire that is wound or unwound can be moved precisely to a desired location inside a work space.

Although an embodiment of the present invention has been described, the technical ideas of the present invention are not restricted to the embodiment presented herein, and another embodiment shall be possible by a person of ordinary skill in the art to which the present invention pertains by supplementing, modifying, deleting and adding elements of the present invention within the same scope of the technical ideas, but this shall be also included in the scope of the technical ideas of the present invention.

1. A winch comprising:
a driving motor;
a driving axle configured to rotate by having a driving force transferred from the driving motor;
a wire drum installed on the driving axle in such a way that the wire drum is rotated by the driving axle and can move along the driving axle, a first screw part formed on an external circumferential surface of lengthwise end thereof; and
a guide part arranged to be parallel to the driving axle and having a second screw part formed on a lateral side that faces the driving axle, the second screw part being extended in a lengthwise direction of the driving axle and engaged with the first screw part,
wherein the wire drum moves along the guide part in such a way that the length of a wire being wound or unwound for one rotation of the wire drum is constant.

2. The winch of claim 1, wherein the wire begins to be wound on or unwound from the wire drum at a predetermined position in a lengthwise direction of the guide part when the wire drum moves along the guide part.

3. The winch of claim 2, wherein a wire outlet facing a direction that is perpendicular to the lengthwise direction of the guide part is formed in the winch, and
wherein the wire begins to be wound on or unwound from the wire drum at a middle position of the wire outlet when the wire drum moves along the guide part.

4. The winch of claim 3, further comprising a supporting roller arranged in between the wire drum and the wire outlet and configured to support the wire passing through the wire outlet in such a way that the wire passes the middle position of the wire outlet.

5. The winch of claim 4, further comprising a supplementary roller arranged to be in contact with or adjacent to an outer circumferential end of the supporting roller in such a way that the wire supported by the supporting roller is prevented from escaping from the supporting roller and having a rotation axis that is parallel to a rotation axis of the supporting roller.

6. The winch of claim 4, further comprising a load cell arranged to be adjacent to the supporting roller in order to measure tension of the wire supported by the supporting roller.

7. The winch of claim 1, wherein the driving axle is a ball spline axle having a groove extended in the lengthwise direction of the driving axle, and
wherein a ball spline nut having balls that are inserted in the groove is formed inside the wire drum.

8. The winch of claim 1, wherein the first screw part of the wire drum is formed on both lengthwise ends of the wire drum.

9. The winch of claim 1, further comprising:
a first encoder installed in the driving motor in order to measure an amount of rotation of the driving motor;
a second encoder installed on an end part of the driving axle in order to measure an amount of rotation of the wire drum; and
a controller configured to receive the amount of rotation of the driving motor measured by the first encoder and the amount of rotation of the wire drum measured by the second encoder and, if there is a difference between a ratio of the measured amount of rotation of the wire drum for the measured amount of rotation of the driving and a predetermined value, to rotate the driving motor in order to compensate for the difference by additionally rotating the wire drum.

10. The winch of claim 9, wherein the wire drum comprises a guide groove spirally formed continuously on an external circumferential surface of the wire drum in such a way that the wire wound on the wire drum is wound in an aligned fashion.

11. The winch of claim 10, further comprising a pinch roller arranged to be parallel to the driving axle and configured to press down the wire wound on the wire drum toward a center of the wire drum.

12. An autonomous mobile apparatus movable in a predetermined work space, the autonomous mobile apparatus comprising:
a mobile platform placed inside the work space;
a winch of claim 1 installed in the mobile platform; and
a wire having one end coupled to a supporting structure defining the work space and the other end coupled to the winch.
